(19) United States
(12) Patent Application Publication
(10) Pub. No.: US 2009/0270050 A1
(43) Pub. Date: Oct. 29, 2009

(54) ACCESSORY FOR HANDHELD ELECTRONIC DEVICE

(76) Inventor: Scott Brown, San Diego, CA (US)

Correspondence Address: CATALYST LAW GROUP, APC, 9710 SCRANTON ROAD, SUITE S-170, SAN DIEGO, CA, 92121, US

(21) Appl. No.: 12/109,219

(22) Filed: Apr. 24, 2008

(51) Int. Cl. H04B 1/38

(52) U.S. Cl. 455/90.3

(57) ABSTRACT

An accessory for improved comfort and security of grasping of a handheld electronic device is disclosed. In a preferred embodiment, the accessory comprises TYVEK® material, or paper-like material made from synthetic fibers that has significant strength properties and repels water. The paper-like material is rolled to form a first loop that is configured to receive an index finger of a user. Also in a preferred embodiment, a second loop is formed to receive a middle finger. The accessory makes holding the electronic device easier and further a user has more freedom to operate the device with a thumb without losing secure grasp of the device. In yet a separate embodiment, the invention may be incorporated into an exterior protective case of the device.

### BACKGROUND OF THE INVENTION

1. Field of the Invention

The present invention pertains generally to accessories useful to improve functionality in handheld devices. More specifically, the present invention relates to devices and methods for comfortably gripping handheld devices.

2. Description of the Prior Art

In recent years, advances in portable electronic devices have yielded lightweight, small-size units consuming a relatively low amount of electrical power. Improvements such as these have resulted in increased frequency and demand of mobile device users. Examples of such devices include cellular phones with email (in addition to without email) and SMS (text messaging) capability as well as iPod®s, GPS devices, MP3 portable music players, handheld PCs, portable electronic game devices, and digital imaging equipment. Additionally, more and more handheld remote transmitting devices are used for operation and control of transmission receiving equipment.

As told by Hamasaki et al., U.S. Pat. No. 7,286,803, entitled PALM-SIZED MOBILE INFORMATION TERMINAL WITH FINGER-INSERTION HOOKING PORTION, it is presupposed that this kind of mobile information terminal is operated as follows. In short, the user grasps and holds the mobile terminal by one hand, and inputs necessary information into the mobile information terminal by the other hand with a key operation and/or a tapping operation with a pen or a finger. However there is a strong desire to operate the mobile information terminal by only one hand (while using a thumb) rather than to operate the mobile information terminal by both hands. Hamasaki and his colleagues go on to mention a Japanese Patent Application, No. 2202-21529 disclosing a mobile device for raising the operability with one hand, however pointing out that the user must keep grasping and therefore is not able to employ a looser, more comfortable grip.

Hamasaki et al. proposes a mobile device that includes a protective frame that is arranged on the edge portion of the case and surrounds the edge portion, and a hooking portion that sticks out outward of the case from a protective frame, and is formed for fingers to be inserted. While this solution may be generally acceptable, a new design is needed with even more features that make it an ideal solution for almost every handheld device, wherein the user strives to become extremely adept at using his/her thumb to extensively operate buttons to perform certain tasks. As stated herein, examples of such devices applicable to the present invention include cellular phones, PDAs, BlackBerries, palmtops, PMPs (portable media players such as iPod®s), portable electronic game consoles, and remote control devices for various equipment.

In light of the situation described herein, it is an object of the present invention to provide an Accessory for Handheld Electronic Devices that provides secure and comfortable grasping of the handheld device while the user operates the device with his/her thumb or thumbs from both hands, and any combination of thumbs, fingers or pens. It is further an object of the present invention to provide a handheld device accessory that is ideal for offering as a promotional item, suitable for furthering brand recognition by including on the device a company name and/or logo. It is yet a further object of the present invention to provide a handheld device accessory that is simple, mass-producible, disposable, adaptable and cost effective.

### BRIEF SUMMARY OF THE INVENTION

The present invention specifically addresses and alleviates the above mentioned deficiencies associated with the prior art. More particularly, the present invention comprises an accessory for a handheld electronic device for improving security and comfort of grasping by a user, comprising: a base portion configured to substantially mate with a surface of the handheld electronic device; and a first loop portion connected to the base portion configured to receive a first finger of the user while grasping the device, the first loop portion also assisting the first finger and the user to securely grasp the handheld device while holding and operating the device.

The accessory for a handheld electronic device for improving security and comfort of grasping by a user is further characterized in that it comprises a second loop portion, adjacent to the first loop portion configured to received a second finger of the user, the first and second loop portions together assisting first and second fingers to securely and comfortably grasp the handheld device while holding and operating the device. Optionally, the accessory may be releasably attached to the device using for example, hook and loop fasteners. Also as an alternative, the invention could employ adhesive material on one side of the base portion, having paper material covering the adhesive material until a time when the accessory is ready for use, at which point the paper is removed to expose the adhesive material.

The invention is further characterized in that the base portion is made from a thin foam material and the first and second loop portions are made from glossy paper material, such as TYVEK®. Additionally, the invention is characterized in that the surface is a rear surface of the device and wherein a user's thumb is able to operate buttons on a front surface of the device.

Alternatively, the first finger is chosen to be a user's index finger and the second finger is a middle finger; or, the first finger is a middle finger and the second finger is a ring finger.

In yet a separate alternative embodiment, the invention is characterized in that the accessory is incorporated into a case or a jacket of the handheld device.

The invention may be further characterized as a method for comfortably and securely grasping a handheld electronic device, the method comprising: providing a strip of elongated paper-like material; forming a first loop portion with the elongated paper-like material; attaching the first loop portion to a back of the handheld electronic device; and mating a user's first finger with the first loop portion, the first loop portion assisting the first finger and the user to securely grasp the handheld device while holding and operating the device.

The aforesaid method of the present invention for comfortably and securely grasping a handheld electronic device further comprises: forming a second loop portion with the elongated paper-like material; and mating a user's second finger with the second loop portion, the first and second loop portions together assisting the first and second fingers and to securely grasp the handheld device while holding and operating the device.

The method of the invention is further characterized wherein the elongated paper-like material comprises TYVEK® material, or similar material with appealing strength properties. Further the method is characterized wherein the attaching the first loop portion to a back of the handheld electronic device comprises using adhesive material and covering the adhesive material until a time when the first loop is to be attached. Alternatively the accessory could be releasably attached to a back of the handheld electronic device with a hook and loop-type fastener. It is further contemplated that the first finger is an index finger.

The invention, in yet another aspect may be characterized as an accessory for a handheld electronic device for improving security and comfort of grasping by a user, comprising: a first loop portion formed from substantially flat paper-like material; and a means for attaching the first loop portion to a back of the handheld electronic device, the first loop portion configured to receive a first finger of the user while grasping the device, the first loop portion further assisting the first finger and the user to securely grasp the handheld device while holding and operating the device.

In this particular embodiment, the invention further includes a second loop portion, adjacent to the first loop portion configured to receive a second finger of the user, the first and second loop portions together assisting first and second fingers to securely and comfortably grasp the handheld device while holding and operating the device. Further the invention includes providing a particular company's logo information for promoting a brand of the company. As in other embodiments, the invention also includes a base portion connected to the first loop portion and wherein the means for attaching comprises adhesive material on one side of the base portion; and paper material covering the adhesive material until a time when the accessory is ready for use, at which point the paper is removed to expose the adhesive material.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

The invention can be better visualized by turning now to the following drawings wherein like elements are expressed using like reference characters.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of an exemplary accessory for handheld electronic device of the present invention;

FIG. 1B is a top plan view of the invention embodiment of FIG. 1A;

FIG. 2A is a perspective view of an alternative invention embodiment;

FIG. 3A illustrates the embodiment shown in FIGS. 1A and 1B mating with a user's hand according to the invention;

FIGS. 3B and 3C further illustrate an embodiment of the present invention and how employed to improve secure grasping of an electronic device according to the present invention;

FIG. 4 illustrates an alternative embodiment of the present invention wherein the accessory is incorporated into a case of the present invention; and

FIG. 5 illustrates a preferred device and method of creating sheets of the present invention.

### DETAILED DESCRIPTION OF PREFERRED EMBODIMENTS

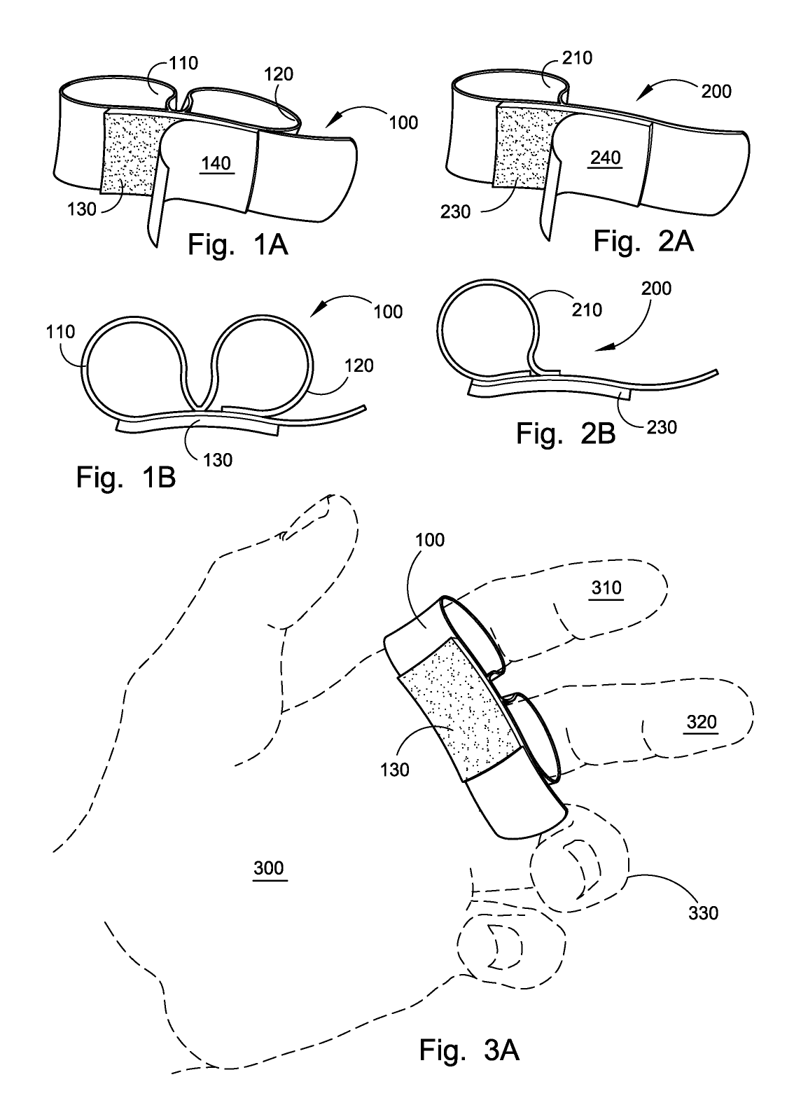

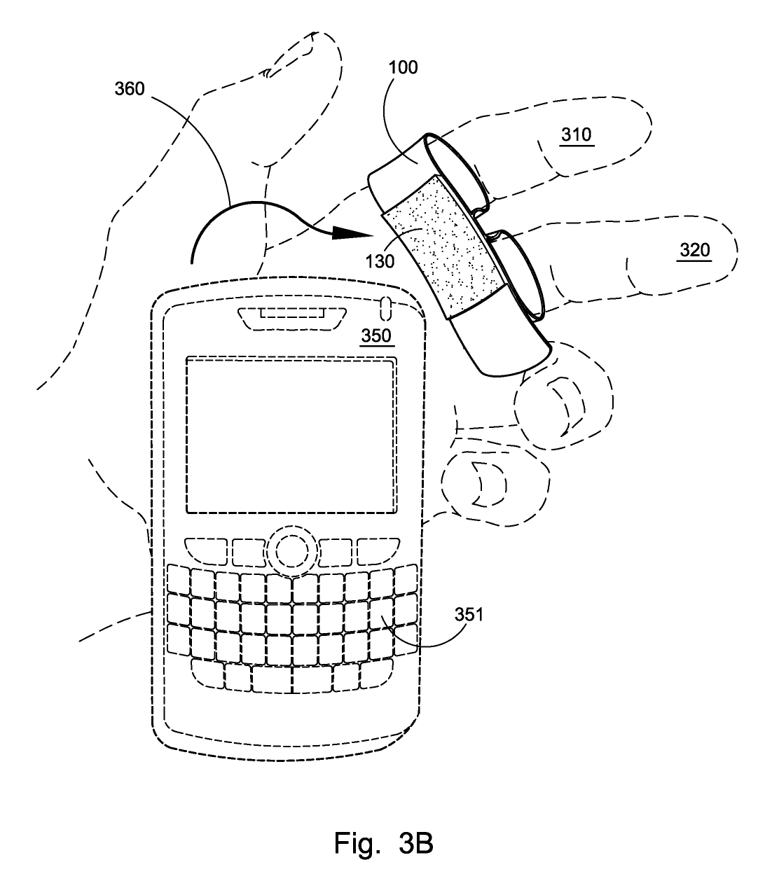

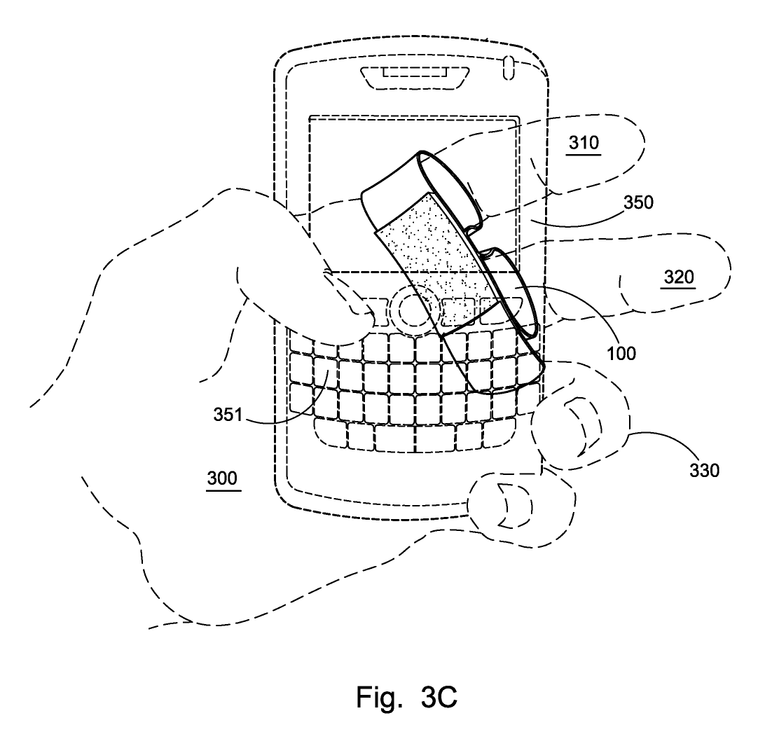

Referring initially to FIG. 1A, an exemplary accessory 100 for an electronic handheld device 350 (FIGS. 3B and 3C) is illustrated. Accessory 100 is originally described as forming a first loop portion 110 configured to receive a first finger 310 (FIG. 3A). First loop portion 310 is further connected to a base portion 130 that is to mate with device 350. FIG. 1B shows a top plan view of the invention embodiment 100. Second loop portion 120 is also provided to receive a second finger 320 according to the invention. First and second loop portions 110, 120 together assist first and second fingers 310, 320 to securely grasp and control the electronic device 350. This particular configuration will assist a user to operate the device 350 with the user's thumb. It is further envisioned that the accessory 100 will allow users to develop greater skill at operating the device while comfortably maintaining control of the device.

In a preferred embodiment, base portion 130, 230 includes adhesive material on a side that is to mate with handheld electronic device 350. Referring to the drawings, the adhesive material of base 130, 230 is illustrated with stippling markings. Prior to use, the adhesive material is covered by a glossy paper material 140, 240 so as to protect its adhesive properties without bonding to the base 130, 230. When in use, base 130, 230 will securely bond to a rear of the device 350 in a manner preferred by the user. In a preferred embodiment, base 130 is a film coated on both sides with different pressure sensitive adhesives. More particularly, a first side that bonds to the invention 100 comprises an aggressive, general purpose, permanent adhesive. The second, opposite side that bonds to the device 350 comprises a low adhesion bonding material. As an example of the magnitude of adhesion, the first side will have adhesion properties in the range of approximately 8.0-0.5 lbs./in. Similarly, an exemplary range for the low adhesion side is approximately in the range of 0.4-0.01 lbs./in. It is further contemplated that the base portion 130, 230 is made from a thin foam material.

Additionally, the accessory 100 may be made from a strong paper-like material that will not pass or absorb water, such as TYVEK®, a registered trademark of E.I. DuPont. TYVEK® is a paper-like material that is comprised of man-made fibers and is very strong, resistant to tear and will pass water vapor but not liquid water.

Referring to FIGS. 2A and 2B, another embodiment of the present invention is illustrated with only a first loop portion 210, but without a second loop portion 120 as illustrated in FIGS. 1A and 1B. It is contemplated that first loops 110, 120 could receive either an index finger 310 or a middle finger 320, whichever is more suited to a particular user.

FIGS. 3A through 3C illustrate an exemplary user's hand 300 comfortably securing, controlling, and gasping an exemplary electronic handheld device 350 according to the present invention. In a first embodiment as illustrated, index 310 and middle 320 fingers are first and second fingers of the invention. In a second embodiment not shown, middle 320 and ring 330 are first and second fingers of the invention. Referring to FIG. 3B, arrow 360 shows how device 350 is bonded to base portion 130 with adhesive material. FIG. 3C shows the entirety of the invention with accessory 100 and device 350 and a user's hand 300. As stated herein, invention 100 assists a user to become adept at operating buttons 351 of the device 350. Importantly, a user can impart control to the device 350 by creating tension with the user's fingers 310, 320, 330.

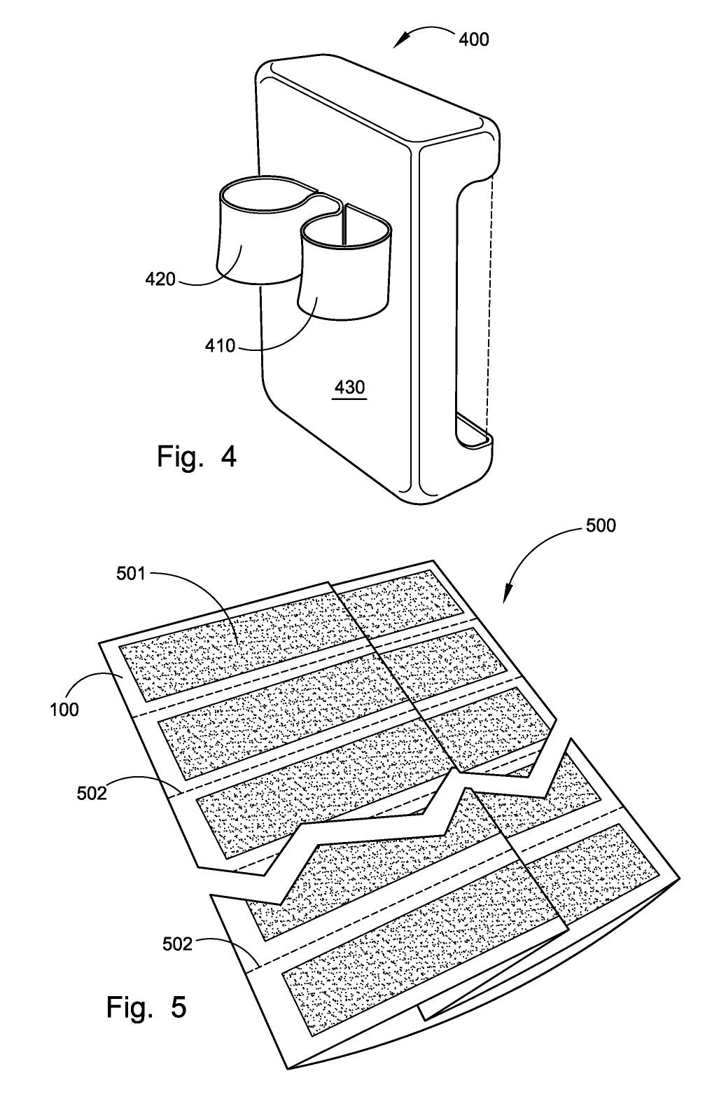

Referring to FIG. 4, another embodiment 400 of the invention is illustrated. In this invention embodiment 400, a jacket or cellular phone case 430 is provided and the accessory is incorporated into the case 400. In other words, accessory is permanently affixed to the case 400 so that if case is made of leather, then the accessory would likely be sown into the case 400 and permanently bonded thereto. As shown, the embodiment 400 includes first loop portion 410 and second loop portion 420.

It is additionally contemplated that the accessory loops 110, 120 or the case embodiment 400 could be made from a variety of materials such as synthetic paper-like fiber composites such as TYVEK®, fabric, leather, plastic, or the like.

Referring to FIG. 5, an apparatus and method for producing individual accessories 100 from a sheet 500 is shown and disclosed. Importantly, the accessories and sheets thereof are substantially flat when produced and presented. As a result the sheets 500 additionally comprise a printable area 501 that can include company branding information for promotional purposes. Sheets 500 further comprise perforations 502 to assist in easily extracting individual accessories from a sheet 500.

While the particular Accessory for Handheld Electronic Device as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. An accessory for a handheld electronic device for improving security and comfort of grasping by a user, comprising:
a base portion configured to substantially mate with a surface of the handheld electronic device; and
a first loop portion connected to the base portion configured to receive a first finger of the user while grasping the device, the first loop portion assisting the first finger and the user to securely grasp the handheld device while holding and operating the device.

2. The accessory for a handheld electronic device for improving security and comfort of grasping by a user of claim 1, further comprising a second loop portion, adjacent to the first loop portion configured to received a second finger of the user, the first and second loop portions together assisting first and second fingers to securely and comfortably grasp the handheld device while holding and operating the device.

3. The accessory for a handheld electronic device for improving security and comfort of grasping by a user of claim 1, wherein the accessory is releasably attached to the device.

4. The accessory for a handheld electronic device for improving security and comfort of grasping by the user of claim 1, further comprising:
adhesive material on one side of the base portion; and
paper material covering the adhesive material until a time when the accessory is ready for use, at which point the paper is removed to expose the adhesive material.

5. The accessory for a handheld electronic device for improving security and comfort of grasping by the user of claim 1, wherein the base portion is made from a thin foam material and the first and second loop portions are made from paper-like material.

6. The accessory for a handheld electronic device for improving security and comfort of grasping by the user of claim 1, wherein the surface is a rear surface of the device and wherein a user's thumb is able to operate buttons on a front surface of the device.

7. The accessory for a handheld electronic device for improving security and comfort of grasping by the user of claim 1, wherein the first finger is an index finger and the second finger is a middle finger.

8. The accessory for a handheld electronic device for improving security and comfort of grasping by the user of claim 1, wherein the first finger is a middle finger and the second finger is a ring finger.

9. The accessory for a handheld electronic device for improving security and comfort of grasping by a user of claim 1, wherein the accessory is incorporated into a case of the handheld device.

10. A method for comfortably and securely grasping a handheld electronic device, the method comprising:
providing a strip of elongated paper-like material;
forming a first loop portion with the elongated paper-like material;
attaching the first loop portion to a back of the handheld electronic device; and
mating a user's first finger with the first loop portion, the first loop portion assisting the first finger and the user to securely grasp the handheld device while holding and operating the device.

11. The method for comfortably and securely grasping a handheld electronic device of claim 10, further comprising:
forming a second loop portion with the elongated paper-like material; and
mating the user's second finger with the second loop portion, the first and second loop portions together assisting the first and second fingers and to securely grasp the handheld device while holding and operating the device.

12. The method for comfortably and securely grasping a handheld electronic device of claim 10, wherein the elongated paper-like material comprises TYVEK® material.

13. The method for comfortably and securely grasping a handheld electronic device of claim 10, wherein the attaching the first loop portion to a back of the handheld electronic device comprises using adhesive material and covering the adhesive material until a time when the first loop is to be attached.

14. The method for comfortably and securely grasping a handheld electronic device of claim 10, wherein the attaching the first loop portion to a back of the handheld electronic device comprises releasably attaching the first loop portion to a back of the handheld electronic device with a hook and loop fastener.

15. The method for comfortably and securely grasping a handheld electronic device of claim 10, wherein the first finger is an index finger.

16. An accessory for a handheld electronic device for improving security and comfort of grasping by a user, comprising:
a first loop portion formed from substantially flat paper-like material; and
a means for attaching the first loop portion to a back of the handheld electronic device, the first loop portion configured to receive a first finger of the user while grasping the device, the first loop portion further assisting the first finger and the user to securely grasp the handheld device while holding and operating the device.

17. The accessory for a handheld electronic device for improving security and comfort of grasping by a user of claim 16, further comprising a second loop portion, adjacent to the first loop portion configured to received a second finger of the user, the first and second loop portions together assisting first and second fingers to securely and comfortably grasp the handheld device while holding and operating the device.

18. The accessory for a handheld electronic device for improving security and comfort of grasping by a user of claim 16, further comprising company logo information for promoting a brand of the company.

19. The accessory for a handheld electronic device for improving security and comfort of grasping by the user of claim 16, further comprising:
a base portion connected to the first loop portion and wherein the means for attaching comprises adhesive material on one side of the base portion; and
paper material covering the adhesive material until a time when the accessory is ready for use, at which point the paper is removed to expose the adhesive material.

20. The accessory for a handheld electronic device for improving security and comfort of grasping by the user of claim 19, wherein the base portion is made from a thin foam material and the first and second loop portions are made from glossy paper material.
